(19) United States
(12) Patent Application Publication
(10) Pub. No.: US 2024/0360297 A1
(43) Pub. Date: Oct. 31, 2024

(54) THERMAL INTERFACE MATERIALS BY POLYMERIZATION INDUCED PHASE SEPARATION

(71) Applicant: Adaptive 3D Technologies, LLC, Plano, TX (US)

(72) Inventors: Benjamin R. LUND, Plano, TX (US); Benjamin BATCHELOR, Plano, TX (US)

(73) Assignee: Adaptive 3D Technologies, LLC, Plano, TX (US)

(21) Appl. No.: 18/285,434

(22) PCT Filed: Apr. 5, 2022
(86) PCT No.: PCT/US2022/023553

§ 371 Date: Oct. 3, 2023

Related U.S. Application Data
(60) Provisional application No. 63/171,015, filed on Apr. 5, 2021.

(51) Int. Cl. C08K 13/02

(52) U.S. Cl. CPC C08K 13/02; C08K 2201/01; C08K 2201/011

(57) ABSTRACT

Disclosed are thermal interface materials having phase separated domains and methods of preparing the same. Exemplary polymer resins solubilize/disperse thermally conductive filler particles in the uncured resin, and, during the cure, the resin may phase separate from the thermally conductive filler particles to form domains of cured resin and domains of conductive filler. Exemplary cured systems comprise: metallic nanoparticles or an aromatic carbon based material, a polyfunctional surfactant, and a crosslinked polymer network; wherein the cured system has domains enriched with the metallic nanoparticles or the aromatic carbon based material and domains enriched with the crosslinked polymer network, and wherein the polyfunctional surfactant is covalently bonded with the crosslinked polymer network. Exemplary methods for making a cured system comprise: applying a magnetic field to form domains enriched with the metallic nanoparticles and domains enriched with the crosslinked polymer network.

This application claims the benefit of priority to U.S. Provisional Application No. 63/171,015 filed Apr. 5, 2021, the disclosure of which is incorporated herein by reference in its entirety.

Disclosed are thermal interface materials having phase separated domains and methods of preparing the same.

Thermal interface materials (TIM) transport thermal energy (e.g., phonons) from one location to another. Some high performing thermal transport materials enable effective translation of thermal energy through regularly ordered atoms (such as crystalline domains, e.g., in diamond or graphene). Areas of disorder (such as crystalline grain boundaries or amorphous regions) lead to, e.g., phonon scatter, dissident resonances, and loss of thermal translation. Most processable materials, however, are poor thermal conductors. Some engineered materials having poor thermal conduction (i.e., thermal insulators) utilize void spaces to minimize thermal conduction and force thermal convection.

There exists a need in microelectronics to enable high thermal and electrical conduction for structures on or across microchips (such as die attach adhesives). For example, there is a need for polymer adhesives (to enable adhesive strength across an interface) loaded with a conductive filler (such as graphene or metal particles). While the conductive fillers (such as graphene) have exhibited excellent thermal conductivities within the conductive fillers themselves (such as in a silver flake or across a sheet of graphene) these conductivities drop off precipitously for transmitting phonons between the filler particles or at the interfaces of the adhesive and the substrate. Accordingly, there is a need for thermal interface materials having domains enriched with high thermal conductivity fillers.

Disclosed herein are polymer resins to solubilize/disperse thermally conductive filler particles in the uncured resin, wherein, during the cure, the resin phase separates from the thermally conductive filler particles to form domains of cured resin and separate domains of conductive filler.

In some embodiments, a system comprises: metallic nanoparticles or an aromatic carbon based material, a polyfunctional surfactant, and a reactive additive; wherein the polyfunctional surfactant is capable of forming a polymer when reacted with the polyfunctional surfactant.

In some embodiments, the system comprises metallic nanoparticles and the metallic nanoparticles comprise a d-block transition metal, a noble metal, a group 11 element, or silver.

In some embodiments, the system comprises metallic nanoparticles and the metallic nanoparticles have a distribution of sizes with an average diameter of <1 μm, <500 nm, <200 nm, <100 nm, <50 nm, <10 nm, <5 nm, or <1 nm.

In some embodiments, the polyfunctional surfactant is nucleophilic.

In some embodiments, the system comprises metallic nanoparticles and the polyfunctional surfactant comprises one or more of a primary alcohol, a secondary alcohol, a tertiary alcohol, a primary amine, a secondary amine, a tertiary amine, a primary thiol, a secondary thiol, and a tertiary thiol.

In some embodiments, the reactive additive comprises electrophilic groups.

In some embodiments, the reactive additive comprises an isocyanate or an epoxide.

In some embodiments, the system comprises metallic nanoparticles and the metallic nanoparticles are mixed with the reactive additive such that the stoichiometric balance of the functional groups on the reactive additive to the free (unbound) reactive surfactant is >10:1, >5:1, >2:1, >1.5:1, >1.1:1, or >1:1.

In some embodiments, the system comprises metallic nanoparticles and the mass to mass ratio of the metallic nanoparticle to polyfunctional surfactant is >95:5, >90:10, >85:15, >80:20, >75:25, or >50:50.

In some embodiments, the system comprises the aromatic carbon based material and the aromatic carbon based material comprises one or more of graphene, carbon nano-tubes, and buckyballs.

In some embodiments, the system comprises the aromatic carbon based material and the aromatic carbon based material has a distribution of sizes with an average diameter of <1 μm, <500 nm, <200 nm, <100 nm, <50 nm, <10 nm, <5 nm, or <1 nm.

In some embodiments, the system comprises the aromatic carbon based material and the polyfunctional surfactant stabilizes a nanoparticle dispersion of the aromatic carbon based material.

In some embodiments, the system comprises the aromatic carbon based material and the polyfunctional surfactant comprises fluorine.

In some embodiments, the aromatic carbon based material and the polyfunctional surfactant comprises mono-fluoromethyl groups, di-fluoromethyl groups, tri-fluoromethyl groups, mono-fluoromethylene groups, di-fluoromethylene groups, or aromatic fluorine groups.

In some embodiments, the nanoparticles are mixed with the reactive additive such that the stoichiometric balance of the functional groups on the reactive additive to the free (unbound) reactive surfactant is >10:1, >5:1, >2:1, >1.5:1, >1.1:1, or >1:1.

In some embodiments, the reactive additive comprises a catalyst.

In some embodiments, the catalyst is a non-nucleophilic, latent catalyst.

In some embodiments, the catalyst is a thermally labile base; wherein the base is a tertiary amine.

In some embodiments, the system comprises metallic nanoparticles and the metallic nanoparticles are magnetic.

Disclosed are cured systems comprising: metallic nanoparticles or an aromatic carbon based material, a polyfunctional surfactant, and a crosslinked polymer network; wherein cured system has domains enriched with the metallic nanoparticles or the aromatic carbon based material and domains enriched with the crosslinked polymer network, and wherein the polyfunctional surfactant is covalently bonded with the crosslinked polymer network.

Disclosed are methods for making a cured system, wherein the cured system comprises the metallic nanoparticles and the metallic nanoparticles are magnetic, wherein the method comprises: applying a magnetic field to form domains enriched with the metallic nanoparticles and domains enriched with the crosslinked polymer network.

In some embodiments, the magnetic field has a magnitude ranging from 0 T to 0.3 T.

In some embodiments, the magnetic field is applied prior to and/or during curing.

In some embodiments, the magnetic field is applied for a duration ranging from 5 seconds to 60 seconds

### BRIEF DESCRIPTION OF THE DRAWINGS

FIG. 1 depicts an exemplary illustration of a thermally conductive filler associated with a polyfunctional surfactant.

FIG. 2 depicts an exemplary method for making a cured system using an applied a magnetic field.

### DEFINITIONS

As used herein, “a” or “an” entity refers to one or more of that entity, e.g., “a compound” refers to one or more compounds or at least one compound unless stated otherwise. As such, the terms “a” (or “an”), “one or more”, and “at least one” are used interchangeably herein.

As used herein, the term “material” refers to the elements, constituents, and/or substances of which something is composed or can be made.

Unless otherwise stated, polyfunctional surfactant having a “primary thiol,” “secondary thiol”, and “tertiary thiol” refers to a polyfunctional surfactant having a thiol with, respectively, one, two, or three substituents on the carbon atom alpha to a thiol group. For example, a primary thiol is of formula HS—CH₂—R for a non-hydrogen substituent R, a secondary thiol is of formula HS—CHR′—R for non-hydrogen substituents R′ and R″, and a tertiary thiol is of formula HS—CR′R″—R for non-hydrogen substituents R′, R″, and R; wherein each of R′, R″, and R are bonded to the alpha carbon, independently selected, and may be the same and/or different from each other.

Unless otherwise stated, polyfunctional surfactant having a “primary alcohol,” “secondary alcohol”, and “tertiary alcohol” refers to a polyfunctional surfactant having an alcohol with, respectively, one, two, or three substituents on the carbon atom alpha to an alcohol group. For example, a primary alcohol is of formula HO—CH₂—R for a non-hydrogen substituent R, a secondary alcohol is of formula HO—CHR′—R for non-hydrogen substituents R′ and R, and a tertiary alcohol is of formula HO—CR′R″—R for non-hydrogen substituents R′, R″, and R; wherein each of R′, R″, and R are bonded to the alpha carbon, independently selected, and may be the same and/or different from each other.

Unless otherwise stated, polyfunctional surfactant having a “primary amine,” “secondary amine”, and “tertiary amine” refers to a polyfunctional surfactant having an amine with, respectively, a singly, a doubly, or a triply substituted nitrogen atom. For example, a primary amine is of formula HN—R for a non-hydrogen substituent R, a secondary amine is of formula T-N—R′—R for non-hydrogen substituents R′ and R, and a tertiary amine is of formula NR′R″—R for non-hydrogen substituents R′, R″, and R, wherein each of R′, R″, and R are bonded to the nitrogen, independently selected, and may be the same and/or different from each other.

Unless otherwise stated, all temperatures refer to the temperature of the environment in which a material is located and may or may not be different from the temperature of the material itself.

### Curable Polymer Systems:

In some embodiments, a system comprises: metallic nanoparticles or an aromatic carbon based material, a polyfunctional surfactant, and a reactive additive; wherein the polyfunctional surfactant is capable of forming a polymer when reacted with the polyfunctional surfactant.

Without wishing to be bound by theory, it is believed that, prior to curing the system, the polyfunctional surfactant stabilizes a dispersion of the metallic nanoparticles or the aromatic carbon based material within the liquid resins. It is believed that, during polymerization, the polyfunctional surfactant is covalently incorporated into a growing polymer crosslinked-network causing polymerization induced phase separation (PIPS). For example, functional groups which stabilize the particle dispersion may be consumed during the polymerization causing the particles to agglomerate and form a particle enriched domain. It is believed that this polymerization induced phase separation forms a cured material having domains enriched in the metallic nanoparticles or the aromatic carbon based material within a matrix of domains enriched in crosslinked-polymer. It is further believed that the domains enriched in the metallic nanoparticles or the aromatic carbon based material provide thermal channels through cured material to facilitate higher thermal conductivity.

In some embodiments, the polymer matrix in a resin state solubilizes the thermally conductive filler. In some embodiments, the thermally conductive particle is tuned to be dispersed in the resin and to phase separate upon polymerization of the resin into separate domains. In some embodiments, the system is configured to be cured using, e.g., heat, light, or a chemical; whereby the resin is triggered to polymerize into a thermoset network and the thermally conductive particles to phase separate.

In some embodiments, a metal particle system is provided wherein ligands, such as thiols, are tuned to decorate the surface of the particles, as a surfactant to solubilize the particles, and to react into the polymer network.

In some embodiments, a thermally conductive, aromatic carbon based system (such as graphene, buckyballs, nanotubes, etc.) is provided, wherein a fluoropolymer system (such as bisphenol AF with bisphenol A diglycidyl ether) is utilized to solubilize the carbonaceous material and then phase separate once curing has been completed.

In some embodiments, the system comprises metallic nanoparticles and the metallic nanoparticles are mixed with the reactive additive such that the stoichiometric balance of the functional groups on the reactive additive to the free (unbound) reactive surfactant is >10:1, >5:1, >2:1, >1.5:1, >1.1:1, or >1:1.

In some embodiments, the system comprises metallic nanoparticles and the mass to mass ratio of the metallic nanoparticle to polyfunctional surfactant is >95:5, >90:10, >85:15, >80:20, >75:25, or >50:50.

In some embodiments, the nanoparticles are mixed with the reactive additive such that the stoichiometric balance of the functional groups on the reactive additive to the free (unbound) reactive surfactant is >10.1, >5:1, >2:1, >1.5:1, >1.1.1, or >1:1.

In some embodiments, the system comprises greater than 50 weight percent of the metallic nanoparticles or the aromatic carbon based material by total weight of the system. In some embodiments, the system comprises greater than 80 weight percent of the metallic nanoparticles or the aromatic carbon based material by total weight of the system. In some embodiments, the system comprises greater than 90 weight percent of the metallic nanoparticles or the aromatic carbon based material by total weight of the system. In some embodiments, the system comprises greater than 95 weight percent of the metallic nanoparticles or the aromatic carbon based material by total weight of the system. In some embodiments, the system comprises from 50 weight percent to 98 weight percent of the metallic nanoparticles or the aromatic carbon based material by total weight of the system.

In some embodiments, the system is a two-part system.

In some embodiments, the metallic nano-particles with excess surfactant comprise one part of a two part system and the reactive additive, with or without catalyst, comprises the second part. In some embodiments, the aromatic carbon based material with excess surfactant comprises one part of a two part system and the reactive additive, with or without catalyst, comprises the second part.

In some embodiments, the two parts of a two part system are mixed and cured at room temperature within 24 hours to form a cured system. In some embodiments, the two parts of a two part system are mixed and cured at an elevated temperature within 24 hours to form a cured system. In some embodiments, the two parts of a two part system are mixed and cured at >150° C. within 24 hours to form a cured system. In some embodiments, the two parts of a two part system are mixed and cured at >150° C. within 24 hours to form a cured system. In some embodiments, the two parts of a two part system are mixed and cured at >150° C. within 12 hours to form a cured system. In some embodiments, the two parts of a two part system are mixed and cured at >150° C. within 2 hours to form a cured system. In some embodiments, the two parts of a two part system are mixed and cured at >150° C. within 1 hour to form a cured system. In some embodiments, the two parts of a two part system are mixed and cured at >150° C. within 30 minutes to form a cured system. In some embodiments, the two parts of a two part system are mixed and cured at >150° C. within 10 minutes to form a cured system.

### Metallic Nanoparticles:

In some embodiments, a system comprises: metallic nanoparticles, a polyfunctional surfactant, and a reactive additive; wherein the polyfunctional surfactant is capable of forming a polymer when reacted with the polyfunctional surfactant.

In some embodiments, the metallic nanoparticles comprise a d-block transition metal, a noble metal, a group 11 element, or silver.

In some embodiments, the metallic nanoparticles have a distribution of sizes with an average diameter of <1 μm, <500 nm, <200 nm, <100 nm, <50 nm, <10 nm, <5 nm, or <1 nm.

In some embodiments, the metallic nanoparticles are mixed with the reactive additive such that the stoichiometric balance of the functional groups on the reactive additive to the free (unbound) reactive surfactant is >10:1, >5:1, >2:1, >1.5:1, >1.1:1, or >1:1.

In some embodiments, the mass to mass ratio of the metallic nanoparticle to polyfunctional surfactant is >95:5, >90:10, >85:15, >80:20, >75:25, or >50:50.

In some embodiments, the system comprises the metal nanoparticles are silver nanoparticles. In some embodiments, the silver nanoparticles have a diameter ranging from 10 nm to 150 nm.

In some embodiments, the metallic nanoparticles are magnetic.

In some embodiments, the metallic nanoparticles are magnetic and comprise at least one chosen from alnico, iron oxide, nickel, neodymium, iron-nickel-cobalt, nickel-plated copper-nickel, and silver coated particles.

In some embodiments, the metallic nanoparticles comprise an alloy of silver.

In some embodiments, the metallic nanoparticles comprise gold.

### Aromatic Carbon Based Materials:

In some embodiments, a system comprises: an aromatic carbon based material, a polyfunctional surfactant, and a reactive additive; wherein the polyfunctional surfactant is capable of forming a polymer when reacted with the polyfunctional surfactant.

In some embodiments, the system comprises the aromatic carbon based material, and the aromatic carbon based material comprises graphene, graphene flakes, graphene sheets, graphene foams, single-walled nano-tubes, multi-walled nano-tubes, or buckyballs.

In some embodiments, the system comprises the aromatic carbon based material, and the aromatic carbon based material comprises a mixture of graphenes, nano-tubes and buckyballs.

In some embodiments, the system comprises the aromatic carbon based material, and the aromatic carbon based material has an average diameter <1 μm, <500 nm, <200 nm, <100 nm, <50 nm, <10 nm, <5 nm, or <1 nm.

In some embodiments, the system comprises the aromatic carbon based material, and aromatic carbon based material in reactive fluorinated surfactant are mixed with the reactive additive such that the stoichiometric balance of the functional groups on the reactive additive to the free (unbound) reactive surfactant are >10:1.

In some embodiments, the system comprises the aromatic carbon based material, and aromatic carbon based material in reactive fluorinated surfactant are mixed with the reactive additive such that the stoichiometric balance of the functional groups on the reactive additive to the free (unbound) reactive surfactant are >5:1.

In some embodiments, the system comprises the aromatic carbon based material, and aromatic carbon based material in reactive fluorinated surfactant are mixed with the reactive additive such that the stoichiometric balance of the functional groups on the reactive additive to the free (unbound) reactive surfactant are >2:1.

In some embodiments, the system comprises the aromatic carbon based material, and aromatic carbon based material in reactive fluorinated surfactant are mixed with the reactive additive such that the stoichiometric balance of the functional groups on the reactive additive to the free (unbound) reactive surfactant are >1.5.1.

In some embodiments, the system comprises the aromatic carbon based material, and aromatic carbon based material in reactive fluorinated surfactant are mixed with the reactive additive such that the stoichiometric balance of the functional groups on the reactive additive to the free (unbound) reactive surfactant are >1.1.1.

In some embodiments, the system comprises the aromatic carbon based material, and aromatic carbon based material in reactive fluorinated surfactant are mixed with the reactive additive such that the stoichiometric balance of the functional groups on the reactive additive to the free (unbound) reactive surfactant are >1:1.

### Polyfunctional Surfactants:

In some embodiments, the system comprises the metallic nanoparticles, and the polyfunctional surfactant polyfunctional surfactant is nucleophilic.

In some embodiments, the system comprises the metallic nanoparticles, and the polyfunctional surfactant stabilizes a dispersion of the metallic nanoparticles.

In some embodiments, the system comprises the metallic nanoparticles, and the polyfunctional surfactant comprises one or more of a primary alcohol, a secondary alcohol, a tertiary alcohol, a primary amine, a secondary amine, a tertiary amine, a primary thiol, a secondary thiol, and a tertiary thiol.

In some embodiments, the system comprises the metallic nanoparticles, and the polyfunctional surfactant comprises one or more of a primary alcohol, a secondary alcohol, a tertiary alcohol, a primary thiol, a secondary thiol, and a tertiary thiol.

In some embodiments, the system comprises the metallic nanoparticles, and the polyfunctional surfactant comprises one or more of a primary alcohol, a secondary alcohol, a primary amine, a secondary amine, a primary thiol, and a secondary thiol.

In some embodiments, the system comprises the metallic nanoparticles, and the polyfunctional surfactant comprises one or more of a primary alcohol, a secondary alcohol, a primary thiol, and a secondary thiol.

In some embodiments, the system comprises the metallic nanoparticles, and the polyfunctional surfactant comprises at least one chosen from 1,2-ethanediol; 1,3-propanediol; 1,4-butanediol; 1,5-pentanediol; 1,6-hexanediol; 1,7-heptanediol; 1,8-octanediol; 1,9-nonanediol; 1,10-decanediol; poly(ethylene glycol), hydroxy terminated; poly(propylene glycol), hydroxy terminated; poly(tetrahydrofuran); polybutadiene, hydroxy terminated; polyester, alcohol terminated; Dipropylene glycol; 1,3-benzenedimethanol; 1,4-Benzenedimethanol; 1,2-ethanediol; 1,3-propanediol; 1,4-butanediol; 1,5-pentanediol; 1,6-hexanediol; 1,7-heptanediol; 1,8-octanediol; 1,9-nonanediol; 1,10-decanediol; poly(ethylene glycol), hydroxy terminated; poly(propylene glycol), hydroxy terminated; poly(tetrahydrofuran); polybutadiene, hydroxy terminated, polyester, alcohol terminated; Dipropylene glycol; 1,3-benzenedimethanol; 1,4-Benzenedimethanol; 1,2-Ethanedithiol; 1,3-propanedithiol; 1,4-butanedithiol; 1,5-pentanedithiol; 1,6-hexanedithiol; 1,8-octanedithiol; 1,10-decanedithiol; 2,2′-(ethylenedioxy)diethanethiol; Pentaerythritol tetrakis(3-mercaptopropionate); Tris[2-(3-mercaptopropionyloxy)ethyl]isocyanate; 1,2-Ethanedithiol; 1,3-propanedithiol; 1,4-butanedithiol; 1,5-pentanedithiol; 1,6-hexanedithiol; 1,8-octanedithiol; 1,10-decanedithiol; 2,2′-(ethylenedioxy)diethanethiol; Pentaerythritol tetrakis(3-mercaptopropionate); Tris[2-(3-mercaptopropionyloxy)ethyl]isocyanate; 1,2-propylene glycol; Butane-1,3-diol; 1,2-propylene glycol; Butane-1,3-diol; Pentaerythritol tetrakis(3-mercaptobutylate); 1,3,5-tris(2-(3-sulfanyl butanoyloxy)ethyl)-1,3,5-triazine-2,4,6-trione; 1,4-bis(3-mercaptobutyryloxy)butane; Pentaerythritol tetrakis(3-mercaptobutylate); 1,3,5-tris(2-(3-sulfanyl butanoyloxy)ethyl)-1,3,5-triazine-2,4,6-trione; 1,4-bis(3-mercaptobutyryloxy)butane; and combinations thereof.

In some embodiments, the system comprises the metallic nanoparticles, and the polyfunctional surfactant comprises a primary alcohol chosen from 1,2-ethanediol; 1,3-propanediol; 1,4-butanediol; 1,5-pentanediol; 1,6-hexanediol; 1,7-heptanediol; 1,8-octanediol; 1,9-nonanediol; 1,10-decanediol; poly(ethylene glycol), hydroxy terminated; poly(propylene glycol), hydroxy terminated; poly(tetrahydrofuran); polybutadiene, hydroxy terminated; polyester, alcohol terminated; Dipropylene glycol; 1,3-benzenedimethanol; 1,4-Benzenedimethanol; 1,2-ethanediol; 1,3-propanediol; 1,4-butanediol; 1,5-pentanediol; 1,6-hexanediol; 1,7-heptanediol; 1,8-octanediol; 1,9-nonanediol; 1,10-decanediol; poly(ethylene glycol), hydroxy terminated; poly(propylene glycol), hydroxy terminated; poly(tetrahydrofuran); polybutadiene, hydroxy terminated; polyester, alcohol terminated; Dipropylene glycol; 1,3-benzenedimethanol; and 1,4-Benzenedimethanol.

In some embodiments, the system comprises the metallic nanoparticles, and the polyfunctional surfactant comprises secondary alcohol chosen from 1,2-propylene glycol; Butane-1,3-diol; 1,2-propylene glycol; and Butane-1,3-diol.

In some embodiments, the system comprises the metallic nanoparticles, and the polyfunctional surfactant comprises a primary thiol chosen from 1,2-Ethanedithiol; 1,3-propanedithiol; 1,4-butanedithiol; 1,5-pentanedithiol; 1,6-hexanedithiol; 1,8-octanedithiol; 1,10-decanedithiol; 2,2′-(ethylenedioxy)diethanethiol; Pentaerythritol tetrakis(3-mercaptopropionate); Tris[2-(3-mercaptopropionyloxy)ethyl]isocyanate; 1,2-Ethanedithiol; 1,3-propanedithiol; 1,4-butanedithiol; 1,5-pentanedithiol; 1,6-hexanedithiol; 1,8-octanedithiol; 1,10-decanedithiol; 2,2′-(ethylenedioxy)diethanethiol; Pentaerythritol tetrakis(3-mercaptopropionate); and Tris[2-(3-mercaptopropionyloxy)ethyl]isocyanate.

In some embodiments, the system comprises the metallic nanoparticles, and the polyfunctional surfactant comprises secondary thiol chosen from Pentaerythritol tetrakis(3-mercaptobutylate); 1,3,5-tris(2-(3-sulfanyl butanoyloxy)ethyl)-1,3,5-triazine-2,4,6-trione; 1,4-bis(3-mercaptobutyryloxy)butane; Pentaerythritol tetrakis(3-mercaptobutylate); 1,3,5-tris(2-(3-sulfanyl butanoyloxy)ethyl)-1,3,5-triazine-2,4,6-trione; and 1,4-bis(3-mercaptobutyryloxy)butane.

In some embodiments, the system comprises the metallic nanoparticles, and the polyfunctional surfactant comprises a primary amine chosen from Jeffamine-D; Jeffamine-ED; Jeffamine-T; Poly(ethylene glycol)diamine; Hexamethylenediamine; 1,4-Diaminobutane, 1,6-Diaminohexane; 1,7-Diaminoheptane; 1,8-Diaminooctane, 1,9-Diaminononane; 1,10-Diaminodecane; 1,12-Diaminododecane; 4,9-Dioxa-1,12-dodecanediamine; 1,8-Diamino-3,6-dioxaoctane; 1,11-Diamino-3,6,9-trioxaundecane; 2-(2-Aminoethoxy)ethylamine; Triethylenetetramine; Diethylenetriamine; Bis(3-aminopropyl)amine; 2,2′-(ethylenedioxy)bis(ethylamine); 3,3′-Diamino-N-methyldipropylamine; 4,7,10-Trioxa-1,13-tridecanediamine; N,N′-bis(3-aminopropyl)-1,3-propanediamine; Bis(hexamethylene)triamine; DAB-Am-4, Polypropylenimine tetramine dendrimer; 1,2-Bis(3-aminopropylamino)ethane; Tetraethylenepentamine; and Tris(2-aminoethyl)amine.

In some embodiments, the system comprises the metallic nanoparticles, and the polyfunctional surfactant comprises a secondary amine chosen from Jeffamine-SD; N,N-Bis[3-(methylamino)propyl]methylamine; 1,4,7-Trimethyldiethylenetriamine; N,N′-Dimethyl-1,3-propanediamine; N,N-Dimethyl-1,6-hexanediamine; N,N′-Dimethyl-1,8-octanediamine; N,N′-Dipropyl-1,6-hexanediamine; and Tris[2-(methylamino)ethyl]amine.

In some embodiments, the system comprises the metallic nanoparticles, and the surfactant is difunctional.

In some embodiments, the system comprises the aromatic carbon based material, and the polyfunctional surfactant stabilizes a nanoparticle dispersion of the aromatic carbon based material.

In some embodiments, the system comprises the aromatic carbon based material, and the polyfunctional surfactant comprises fluorine.

In some embodiments, the system comprises the aromatic carbon based material and the polyfunctional surfactant comprises mono-fluoromethyl groups, di-fluoromethyl groups, tri-fluoromethyl groups, mono-fluoromethylene groups, di-fluoromethylene groups, or aromatic fluorine groups.

In some embodiments, the system comprises the aromatic carbon based material and the polyfunctional surfactant comprises at least one chosen from Hexafluoro-1,5-pentanediol; Hexafluoro-2,3-bis(trifluoromethyl)-2,3-butanediol; Hexadecafluoro-1,10-decanediol; 2,2,3,3-Tetrafluoro-1,4-butanediol; and Octafluoro-1,6-hexanediol.

In some embodiments, the system comprises the aromatic carbon based material and the polyfunctional surfactant comprises is difunctional.

In some embodiments, the system comprises the metallic nanoparticles and the surfactant comprises a surfactant used to stabilize the nanoparticle dispersion wherein the surfactant is nucleophilic and wherein the surfactant is polyfunctional; a surfactant used to stabilize the nanoparticle dispersion wherein the surfactant is difunctional; a surfactant used to stabilize the nanoparticle dispersion wherein the surfactant is functionalized with primary alcohols; a surfactant used to stabilize the nanoparticle dispersion wherein the surfactant is functionalized with secondary alcohols; a surfactant used to stabilize the nanoparticle dispersion wherein the surfactant is functionalized with tertiary alcohols; a surfactant used to stabilize the nanoparticle dispersion wherein the surfactant is functionalized with mixture of primary, secondary and/or tertiary alcohols; a surfactant used to stabilize the nanoparticle dispersion wherein the surfactant is functionalized with primary amines; a surfactant used to stabilize the nanoparticle dispersion wherein the surfactant is functionalized with secondary amines; a surfactant used to stabilize the nanoparticle dispersion wherein the surfactant is functionalized with tertiary amines; a surfactant used to stabilize the nanoparticle dispersion wherein the surfactant is functionalized with mixture of primary, secondary and/or tertiary amines; a surfactant used to stabilize the nanoparticle dispersion wherein the surfactant is functionalized with primary thiols; a surfactant used to stabilize the nanoparticle dispersion wherein the surfactant is functionalized with secondary thiols; a surfactant used to stabilize the nanoparticle dispersion wherein the surfactant is functionalized with tertiary thiols; a surfactant used to stabilize the nanoparticle dispersion wherein the surfactant is functionalized with mixture of primary, secondary and/or tertiary thiols; or a surfactant used to stabilize the nanoparticle dispersion wherein the surfactant is functionalized with mixture of alcohols, amines and/or thiols in primary, secondary and/or tertiary functionalization.

In some embodiments, the system comprises the aromatic carbon based material, and the polyfunctional surfactant comprises one or more of a primary amine, a secondary amine, and a tertiary amine.

In some embodiments, the system comprises the aromatic carbon based material and the surfactant comprises a surfactant used to stabilize the nanoparticle dispersion wherein the surfactant contains fluorine; a surfactant used to stabilize the nanoparticle dispersion wherein the surfactant contains mono-fluoromethyl groups; a surfactant used to stabilize the nanoparticle dispersion wherein the surfactant contains di-fluoromethyl groups; a surfactant used to stabilize the nanoparticle dispersion wherein the surfactant contains tri-fluoromethyl groups; a surfactant used to stabilize the nanoparticle dispersion wherein the surfactant contains mono-fluoromethylene groups; a surfactant used to stabilize the nanoparticle dispersion wherein the surfactant contains di-fluoromethylene groups; a surfactant used to stabilize the nanoparticle dispersion wherein the surfactant contains aromatic fluorine groups; a fluorinated surfactant used to stabilize the nanoparticle dispersion wherein the surfactant is nucleophilic and wherein the surfactant is polyfunctional; a fluorinated surfactant used to stabilize the nanoparticle dispersion wherein the surfactant is difunctional; a fluorinated surfactant used to stabilize the nanoparticle dispersion wherein the surfactant is functionalized with primary alcohols; a fluorinated surfactant used to stabilize the nanoparticle dispersion wherein the surfactant is functionalized with secondary alcohols; a fluorinated surfactant used to stabilize the nanoparticle dispersion wherein the surfactant is functionalized with tertiary alcohols; a fluorinated surfactant used to stabilize the nanoparticle dispersion wherein the surfactant is functionalized with mixture of primary, secondary and/or tertiary alcohols; a fluorinated surfactant used to stabilize the nanoparticle dispersion wherein the surfactant is functionalized with primary thiols; a fluorinated surfactant used to stabilize the nanoparticle dispersion wherein the surfactant is functionalized with secondary thiols; a fluorinated surfactant used to stabilize the nanoparticle dispersion wherein the surfactant is functionalized with tertiary thiols; a fluorinated surfactant used to stabilize the nanoparticle dispersion wherein the surfactant is functionalized with mixture of primary, secondary and/or tertiary thiols; or a fluorinated surfactant used to stabilize the nanoparticle dispersion wherein the surfactant is functionalized with mixture of alcohols and/or thiols in primary, secondary and/or tertiary functionalization.

### Reactive Additives:

In some embodiments, the system comprises a reactive additive.

In some embodiments, the reactive additive comprises electrophilic groups such as isocyanates and epoxies.

In some embodiments, the reactive additive comprises an isocyanate.

In some embodiments, the reactive additive comprises a difunctional isocyanate.

In some embodiments, the reactive additive comprises a polyfunctional isocyanate.

In some embodiments, the reactive additive comprises an aliphatic isocyanate.

In some embodiments, the reactive additive comprises a polyfunctional aliphatic isocyanate.

In some embodiments, the reactive additive comprises polyfunctional aliphatic isocyanate of functionality <6.

In some embodiments, the reactive additive comprises polyfunctional aliphatic isocyanate of functionality 6.

In some embodiments, the reactive additive comprises an aromatic isocyanate.

In some embodiments, the reactive additive comprises a polyfunctional aromatic isocyanate.

In some embodiments, the reactive additive comprises a polyfunctional aromatic isocyanate of functionality <6.

In some embodiments, the reactive additive comprises a polyfunctional aromatic isocyanate of functionality >6.

In some embodiments, the reactive additive comprises an epoxide.

In some embodiments, the reactive additive comprises a difunctional epoxide.

In some embodiments, the reactive additive comprises a polyfunctional epoxide.

In some embodiments, the reactive additive comprises an aliphatic epoxide.

In some embodiments, the reactive additive comprises a polyfunctional aliphatic epoxide.

In some embodiments, the reactive additive comprises a polyfunctional aliphatic epoxide of functionality <6.

In some embodiments, the reactive additive comprises a polyfunctional aliphatic epoxide of functionality >6.

In some embodiments, the reactive additive comprises an aromatic epoxide.

In some embodiments, the reactive additive comprises a polyfunctional aromatic epoxide.

In some embodiments, the reactive additive comprises a polyfunctional aromatic epoxide of functionality <6.

In some embodiments, the reactive additive comprises a polyfunctional aromatic epoxide of functionality >6.

In some embodiments, the reactive additive comprises an epoxide chosen from Tris(2,3-epoxypropyl) isocyanurate; Tris(4-hydroxyphenyl)methane triglycidyl ether; Ethylene Glycol Diglycidyl Ether; Neopentyl Glycol Diglycidyl Ether; Trimethylolpropane triglycidyl ether; Tris(4-hydroxyphenyl)methane triglycidyl ether; 4,4′-Methylenebis(N,N-diglycidylaniline); Bisphenol A propoxylate diglycidyl; 2,2-Bis(4-glycidyloxyphenyl) propane; Glycerol diglycidyl ether; Poly(propylene glycol) diglycidyl ether; Resorcinol diglycidyl ether; 1,4-Butanediol diglycidyl ether; Bis[4-(glycidyloxy)phenyl]methane; Tris(2,3-epoxypropyl) isocyanurate; Tris(4-hydroxyphenyl)methane triglycidyl ether; Ethylene Glycol Diglycidyl Ether, Neopentyl Glycol Diglycidyl Ether, Trimethylolpropane triglycidyl ether; Tris(4-hydroxyphenyl)methane triglycidyl ether; 4,4′-Methylenebis(N,N-diglycidylaniline); Bisphenol A propoxylate diglycidyl; 2,2-Bis(4-glycidyloxyphenyl) propane; Glycerol diglycidyl ether; Poly(propylene glycol) diglycidyl ether; Resorcinol diglycidyl ether; 1,4-Butanediol diglycidyl ether; and Bis[4-(glycidyloxy)phenyl]methane.

In some embodiments, the reactive additive comprises an isocyanate chosen from Isophorone diisocyante; Ocatdecyl isocyanate; Hexamethylene diisocyante; 4,4′-Methylenebis(cyclohexyl isocyanate); Diphenylmethane-4,4′-diisocyanate; Poly(hexamethylene diisocyanate); 1,3,5-triisocyanto-2-methylbenzene; 1,4-diisocyanatobutane; 1,12-Diisocyanateododecane; 1,3-Bis(isocyanatomethyl)cyclohexane; 1,4-phenylene diisocyanate; 1,3-Phenylene diisocyanate; 1,8-Diisocyanatooctane; Isophorone diisocyante; Ocatdecyl isocyanate; Hexamethylene diisocyante; 4,4′-Methylenebis(cyclohexyl isocyanate); Diphenylmethane-4,4′-diisocyanate; Poly(hexamethylene diisocyanate); 1,3,5-triisocyanto-2-methylbenzene; 1,4-diisocyanatobutane; 1,12-Diisocyanateododecane; 1,3-Bis(isocyanatomethyl)cyclohexane; 1,4-phenylene diisocyanate; 1,3-Phenylene diisocyanate; and 1,8-Diisocyanatooctane.

In some embodiments, the reactive additive further comprises a catalyst.

In some embodiments, the catalyst is non-nucleophilic.

In some embodiments, the catalyst is a latent catalyst.

In some embodiments, the catalyst is a non-nucleophilic tertiary amine.

In some embodiments, the catalyst is a non-nucleophilic thermally labile base.

In some embodiments, the catalyst is a non-nucleophilic thermally labile base having a tertiary amine.

In some embodiments, the catalyst comprises tributylamine or triethylamine.

In some embodiments, the catalyst comprises a latent catalyst chosen from 1,8-Diazabicyclo[5.4.0]undec-7-ene; N,N-Diisopropylethylamine, 1,5-Diazabicyclo[4.3.0]non-5-ene; 2,6-Di-tert-butylpyridine; Phosphazine; Lithium diisopropylamide; Lithium tetramethylpiperidide; and Potassium bis(trimethylsilyl)amide.

In some embodiments, the catalyst comprises a thermally labile base chosen from Dicyandiamide; Cyclohexyl tosylate; Diphenyl(methyl)sulfonium tetrafluoroborate; and Triphenylsulphonium nonaflate.

### Curing a System:

A cured system can be prepared by curing any one of the curable systems disclosed herein. In some embodiments, curing comprises a polymerization reaction such as, for example, a condensation reaction. In some embodiments, curing is thermally initiated by heating the system above a threshold temperature. In some embodiments, curing is photoinitiated by exposing the system to a light source. In some embodiments, curing is chemically initiated by adding a polymerization catalyst. In some embodiments, curing is initiated by a latent catalyst upon exposure to, e.g., heating, light, or a chemical. In some embodiments, curing is initiated by a thermally labile base when the system is heated above a threshold temperature. In some embodiments, curing is initiated by a photolabile catalyst when the system is exposed to a light source.

In some embodiments, an electromagnetic field is applied to a system before, during, and/or after curing.

In some embodiments, an electromagnetic field is a static magnetic field.

In some embodiments, the magnetic field is applied for a duration ranging from 5 seconds to 60 seconds.

In some embodiments, the cured polymers are thermally annealed at >150° C. for 1 hour to drive the reaction to completion and to cause the carbonaceous nano-particles to align. In some embodiments, the cured polymers are thermally annealed at >200° C. for 1 hour to drive the reaction to completion and to cause the carbonaceous nano-particles to align. In some embodiments, the cured polymers are thermally annealed at >300° C. for 1 hour to drive the reaction to completion and to cause the carbonaceous nano-particles to align.

In some embodiments, the cured polymers are thermally annealed at >150° C. for 1 hour to drive the reaction to completion and to cause the metallic nano-particles to fuse. In some embodiments, the cured polymers are thermally annealed at >200° C. for 1 hour to drive the reaction to completion and to cause the metallic nano-particles to fuse. In some embodiments, the cured polymers are thermally annealed at >300° C. for 1 hour to drive the reaction to completion and to cause the metallic nano-particles to fuse.

In some embodiments, the thermal conductivity increases at least 100% upon thermal annealing. In some embodiments, the thermal conductivity increases at least 200% upon thermal annealing. In some embodiments, the thermal conductivity increases at least 300% upon thermal annealing. In some embodiments, the thermal conductivity increases at least 1000% upon thermal annealing. In some embodiments, the thermal conductivity increases at least 5000% upon thermal annealing. In some embodiments, the thermal conductivity increases at least 10000% upon thermal annealing.

In some embodiments, a system is coated onto a carbon based foam to enable adhesion, thermal and electrical conductivity between the foam and a substrate.

In some embodiments, a system is coated onto a carbon based foam to enable adhesion, thermal and electrical conductivity between the foam and a chip.

In some embodiments, a system is coated onto a carbon based foam to enable adhesion, thermal and electrical conductivity between the foam and a die.

In some embodiments, a system is coated onto a carbon based foam to enable adhesion, thermal and electrical conductivity between the foam and a printed circuit board.

### Cured System:

In some embodiments, a cured system comprises: metallic nanoparticles or an aromatic carbon based material, a polyfunctional surfactant, and a crosslinked polymer network; wherein cured system has domains enriched with the metallic nanoparticles or the aromatic carbon based material and domains enriched with the crosslinked polymer network, and wherein the polyfunctional surfactant is covalently bonded with the crosslinked polymer network.

A cured system can be prepared by curing any one of the curable systems disclosed herein.

In some embodiments, the domains enriched with the metallic nanoparticles or the aromatic carbon based material are continuous channels passing through the material.

In some embodiments, the cured system comprises from 80 weight % to 98 weight percent of the domains enriched with the metallic nanoparticles or the aromatic carbon based material. In some embodiments, the cured system comprises from 80 weight % to 95 weight percent of the domains enriched with the metallic nanoparticles or the aromatic carbon based material. In some embodiments, the cured system comprises from 80 weight % to 90 weight percent of the domains enriched with the metallic nanoparticles or the aromatic carbon based material.

### Exemplary Metal Nanoparticle Based System:

In some embodiments, a metal nanoparticle system can be prepared by: (1) providing silver nanoparticle; (2) decorating the surface of the nanoparticles with a polyfunctional thiol or mixture of thiols such that the system is saturated and excess thiol exists in the system as a solvent; (3) adding a polyisocyanate to the thiol/nano particle mixture, along with a base, such that the stoichiometric ratio of the isocyanates are greater than those of the free thiols (solvent) in the system and react with the bound isocyanates to go to completion; (4) curing such that, as the free thiols are consumed, coordinated thiols (acting as a surfactant to the nano-particles) are released and polymerize, driving the nanoparticles into separate phases from the forming polymer (e.g., phase #1, the curing, amorphous, thio-isocyante; phase #2, the condensed metal particles which are surfactant free or with insufficient surfactant to enable solvation; phase #3, the intermediate phase between the particles and polymer where both particles and polymer are trapped); and (5) sintering the system to complete the polymerization reaction and to allow the silver nano-particles to reflow/agglomerate and form conductive channels.

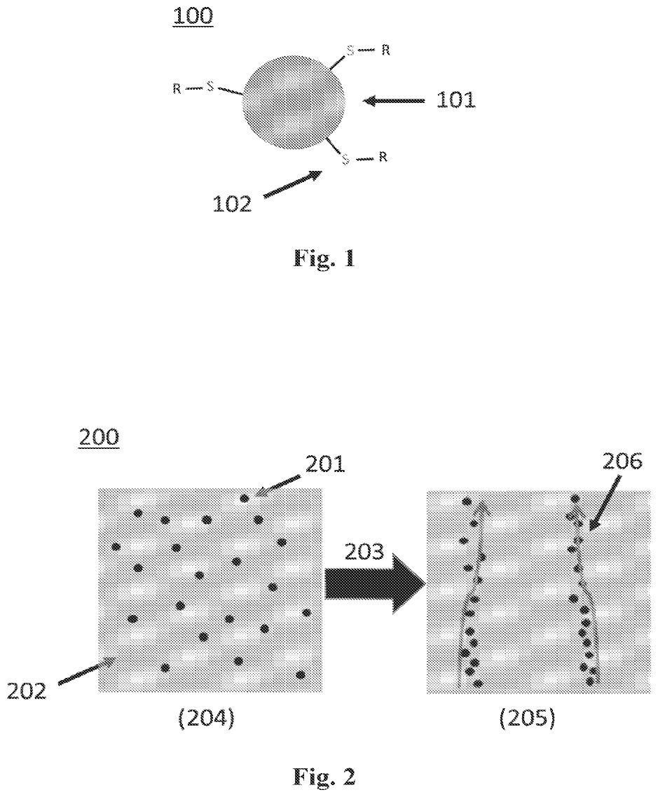

FIG. 1 depicts an exemplary illustration of a thermally conductive filler (101) associated with a polyfunctional surfactant (102).

### Exemplary Electromagnetically Enhance Phase Separation:

In some embodiments, the system comprises magnetic particles and an electromagnetic field is applied to a system before, during, and/or after curing. In some embodiments, the system comprises magnetic particles and an electromagnetic field is applied to a system before and/or during curing.

Without wishing to be bound by theory, it is believed that applying an electromagnetic field before, during, and/or after curing causes an alignment of the magnetic particles such that more regular through-channels are formed. For example, it is believed that while a system undergoes polymerization induced phase separation, an electromagnetic field can be used to enhance the regularity and/or continuity of domains enriched with the magnetic particles and may improve the thermal contact within such domains. It is also believed that use of an electromagnetic field may allow the formation of through-channels even when the amount of magnetic particles is below the percolation threshold.

In some embodiments, a method for making the cured system comprises applying a magnetic field to form domains enriched with the metallic nanoparticles and domains enriched with the crosslinked polymer network, wherein the cured system comprises metallic nanoparticles and the metallic nanoparticles are magnetic.

In some embodiments, the magnetic field strength ranges from 0 T to 0.3 T.

In some embodiments, the system comprises magnetic nanoparticles below the percolation threshold of the nanoparticles.

FIG. 2 depicts an exemplary method for making a cured system using an applied magnetic field. In FIG. 2. (204) is a system comprising magnetic particles (201) and in a matrix of surfactant and reactive additive (202). Curing and applying a magnetic field (203) to (204) causes an ordering of the magnetic particles (206) and forms a cured system (205) comprising domains enriched in the magnetic particles and domains enriched in the crosslinked polymer.

Claims or descriptions that include “or” or “and/or” between at least one members of a group are considered satisfied if one, more than one, or all of the group members are present in, employed in, or otherwise relevant to a given product or process unless indicated to the contrary or otherwise evident from the context. The disclosure includes embodiments in which exactly one member of the group is present in, employed in, or otherwise relevant to a given product or process. The disclosure includes embodiments in which more than one, or all the group members are present in, employed in, or otherwise relevant to a given product or process.

Furthermore, the disclosure encompasses all variations, combinations, and permutations in which at least one limitation, element, clause, and descriptive term from at least one of the listed claims is introduced into another claim. For example, any claim that is dependent on another claim can be modified to include at least one limitation found in any other claim that is dependent on the same base claim. Where elements are presented as lists, such as, e.g., in Markush group format, each subgroup of the elements is also disclosed, and any element(s) can be removed from the group. It should be understood that, in general, where the disclosure, or aspects of the disclosure, is/are referred to as comprising particular elements and/or features, embodiments of the disclosure or aspects of the disclosure consist, or consist essentially of, such elements and/or features. For purposes of simplicity, those embodiments have not been specifically set forth in haec verba herein. Where ranges are given, endpoints are included. Furthermore, unless otherwise indicated or otherwise evident from the context and understanding of one of ordinary skill in the art, values that are expressed as ranges can assume any specific value or sub range within the stated ranges in different embodiments of the disclosure, unless the context clearly dictates otherwise.

Those of ordinary skill in the art will recognize or be able to ascertain using no more than routine experimentation, many equivalents to the specific embodiments of the disclosure described herein. Such equivalents are intended to be encompassed by the following claims.

1. A system comprising:
metallic nanoparticles or an aromatic carbon-based material;
a polyfunctional surfactant; and
a reactive additive,
wherein the polyfunctional surfactant is capable of forming a polymer when reacted with the reactive additive.

2. The system according to claim 1, wherein:
the system comprises the metallic nanoparticles, and
the metallic nanoparticles comprise a d-Block transition metal, a noble metal, a Group 11 element, or silver.

3. The system according to claim 1, wherein:
the system comprises the metallic nanoparticles, and
the metallic nanoparticles have a distribution of sizes with an average diameter of less than 1 μm.

4. The system according to claim 1, wherein the polyfunctional surfactant is nucleophilic.

5. (canceled)

6. The system according to claim 1, wherein the reactive additive comprises electrophilic groups.

7. (canceled)

8. The system according to claim 1, wherein:
the system comprises the metallic nanoparticles, and
the metallic nanoparticles are mixed with the reactive additive such that the stoichiometric balance of functional groups of the reactive additive to functional groups of the free (unbound) polyfunctional surfactant is greater than 1:1.

9. The system according to claim 1, wherein:
the system comprises the metallic nanoparticles, and
the mass-to-mass ratio of the metallic nanoparticles to the polyfunctional surfactant is greater than 50:50.

10. The system according to claim 1, wherein:
the system comprises the aromatic carbon-based material, and
the aromatic carbon-based material comprises at least of graphene, carbon nano-tubes, or buckyballs.

11. The system according to claim 1, wherein:
the system comprises the aromatic carbon-based material, and
the aromatic carbon-based material has a distribution of sizes with an average diameter of less than 1 μm.

12. The system according to claim 1, wherein:
the system comprises a nanoparticle dispersion of the aromatic carbon-based material, and
the polyfunctional surfactant stabilizes the nanoparticle dispersion of the aromatic carbon-based material.

13. The system according to claim 12, wherein the polyfunctional surfactant comprises fluorine.

14. (canceled)

15. The system according to claim 12, wherein the nanoparticle dispersion of the aromatic carbon-based material is mixed with the reactive additive such that the stoichiometric balance of functional groups of the reactive additive to functional groups of the free (unbound) polyfunctional surfactant is greater than 1:1.

16. The system according to claim 1, wherein the reactive additive comprises a catalyst.

17. The system according to claim 16, wherein the catalyst is at least one of a non-nucleophilic catalyst or a latent catalyst.

18. (canceled)

19. The system according to claim 1, wherein:
the system comprises the metallic nanoparticles, and
the metallic nanoparticles are magnetic.

20. A system comprising:
metallic nanoparticles or an aromatic carbon-based material;
a polyfunctional surfactant; and
a crosslinked polymer network;
wherein the system has domains enriched with the metallic nanoparticles or the aromatic carbon-based material and domains enriched with the crosslinked polymer network, and
wherein the polyfunctional surfactant is covalently bonded with the crosslinked polymer network.

21. A method for making the system according to claim 20, wherein the system comprises the metallic nanoparticles and the metallic nanoparticles are magnetic, comprising applying a magnetic field to the system to form the domains enriched with the metallic nanoparticles and the domains enriched with the crosslinked polymer network.

22. The method according to claim 21, wherein the magnetic field has a magnitude ranging from 0 T to 0.3 T.

23. The method according to claim 22, wherein applying the magnetic field comprises applying the magnetic field prior to and/or during curing of the system.

24. The method according to claim 23, wherein applying the magnetic field comprises applying the magnetic field is a time ranging from 5 seconds to 60 seconds.
